(19) United States
(12) Patent Application Publication
(10) Pub. No.: US 2026/0352313 A1
(43) Pub. Date: Nov. 5, 2026

(54) ANTENNA DEVICE

(71) Applicant: NTT, Inc., Tokyo (JP)

(72) Inventors: Hiroyuki FUKUMOTO, Musashino-shi (JP); Yosuke FUJINO, Musashino-shi (JP); Seiji OMORI, Musashino-shi (JP); Yuya ITO, Musashino-shi (JP); Miharu OIWA, Musashino-shi (JP); Ryota OKUMURA, Musashino-shi (JP)

(73) Assignee: NTT, Inc., Tokyo (JP)

(21) Appl. No.: 18/997,690

(22) PCT Filed: Jul. 26, 2022
(86) PCT No.: PCT/JP2022/028803

§ 371 Date: Jan. 22, 2025

(51) Int. Cl. H04B 7/08; H04B 11/00

(52) U.S. Cl. CPC H04B 7/0802; H04B 11/00

(57) ABSTRACT

One aspect of the present invention is an antenna device including N (N is an integer of 3 or more) antenna elements that receive a sound wave or a radio wave, in which the antenna elements are arranged at positions where a steering vector corresponding to an incidence angle θ of a certain sound wave or radio wave and a steering vector corresponding to an incidence angle θ_d (θ_d is −π/2 to +π/2) of another sound wave or radio wave are not primary dependent on each other.

### TECHNICAL FIELD

The present invention relates to a technique for receiving a wireless signal transmitted using radio waves or sound waves (including ultrasonic waves).

### BACKGROUND ART

In a wide-band underwater acoustic communication system having a specific band exceeding several tens of percent, a waveform is easily distorted by inter-symbol-interference (ISI) caused by a multipath wave from the sea surface or the sea floor or co-channel interference (CCI) caused by an interference wave from another system. Therefore, in such an underwater acoustic communication system, it is necessary to perform equalization processing by a receiver. Such equalization processing is not unique to acoustic communication in water, and is also performed in communication using radio waves.

In the following description, the term “antenna” is used as a term representing a concept including not only a configuration for receiving a radio wave but also a configuration for receiving a sound wave (including an ultrasonic wave). In the following description, a wave that may affect reception of a desired wave (direct wave) to be received, such as a multipath wave or an interference wave, is referred to as an “unwanted wave”.

In the signal processing using the array antenna, it is possible to remove unwanted waves by utilizing both of the time-space regions. Therefore, a compensation effect is high in signal processing using an array antenna as compared with a general time domain equalizer. Therefore, signal processing using an array antenna may be used in underwater communication. For example, there is a method in which a finite impulse response (FIR) filter and a feed-back (FB) filter for each array antenna are provided, and filter coefficients are optimized using an optimization algorithm such as a least mean square (LMS) method or a recursive least square (RLS) method (see, for example, Non Patent Literature 1 and Non Patent Literature 2). The gain in the frequency-spatial direction can be controlled by controlling the filter coefficient. Then, by controlling the gain in the frequency-spatial direction, a desired wave can be extracted and an unwanted wave can be removed.

The suppression performance of unwanted waves in the spatial region is fundamentally determined by the shape of the array antenna. Since the size of the aperture of the array antenna determines the spatial resolution, in general, a wider aperture improves the performance of suppressing unwanted waves. In other words, as the size of the entire array antenna is larger, an unwanted wave having a small angle difference from the desired wave can be more effectively suppressed.

However, it is necessary to arrange the antenna elements at intervals equal to or less than a half wavelength of the shortest wavelength (highest frequency) of the band so that spatial aliasing does not occur in the transmission frequency band. Spatial aliasing means that a combination of primary dependent arrival directions occurs when the arrival directions of signals are expressed as vectors using a phase difference between antenna elements. In the following description, a vector indicating an arrival direction of a signal is referred to as a “steering vector”.

### CITATION LIST

### Non Patent Literature

Non Patent Literature 1: M. Johnson, L. Freitag and M. Stojanovic, “Improved Doppler tracking and correction for underwater acoustic communications,” 1997 IEEE International Conference on Acoustics, Speech, and Signal Processing, 1997, pp. 575-578 vol. 1, doi: 10.1109/ICASSP.1997.599703.
Non Patent Literature 2: H. Fukumoto, Y. Fujino, M. Nakano, K. Sakamoto and T. Tsubaki, “Field Experiments Demonstrating Mbps-Class Underwater Acoustic Communication with Spatio-Temporal Equalization,” Global Oceans 2020: Singapore-U.S. Gulf Coast, 2020, pp. 1-6, doi: 10.1109/IEEECONF38699.2020.9389018.

### SUMMARY OF INVENTION

### Technical Problem

However, in some cases, the antenna elements cannot be arranged at an interval equal to or less than a half wavelength according to the aperture width of the array according to the angular resolution due to device restrictions and the like. In this case, spatial aliasing may occur within the transmission frequency band depending on the array pattern. Specifically, there are the following cases.

When the steering vectors indicating the arrival directions of the desired wave and the unwanted wave are primary dependent on each other, if the equalizer attempts to spatially form a null for the unwanted wave, a null is also formed in the desired wave direction. On the other hand, if the main lobe is directed in the desired wave direction, the main lobe is also directed in the arrival direction of the unwanted wave, and the unwanted wave cannot be suppressed. Therefore, regardless of with which adaptive algorithm the filter coefficient is optimized, it is not possible to effectively suppress an unwanted wave and extract a desired wave, and equalization performance deteriorates.

In view of the above circumstances, an object of the present invention is to provide a technique capable of improving the performance of equalization processing performed when a desired wave that is a radio wave or a sound wave (including an ultrasonic wave) to be received is received.

### Solution to Problem

One aspect of the present invention is an antenna device including N (N is an integer of 3 or more) antenna elements that receive a sound wave or a radio wave, in which the antenna elements are arranged at positions where a steering vector corresponding to an incidence angle θ of a certain sound wave or radio wave and a steering vector corresponding to an incidence angle θ_d (θ_d is −π/2 to +π/2) of another sound wave or radio wave are not primary dependent on each other.

### Advantageous Effects of Invention

According to the present invention, it is possible to improve performance of equalization processing performed when a desired wave that is a radio wave or a sound wave (including an ultrasonic wave) to be received is received.

### BRIEF DESCRIPTION OF DRAWINGS

FIG. 1 is a diagram illustrating a specific example of arrangement of antenna elements 11 in an antenna device 10 configured as an array antenna.

FIG. 2 is a diagram illustrating a configuration example of a reception system 100.

FIG. 3 is a diagram illustrating an outline of a computer simulation.

FIG. 4 is a diagram illustrating an outline of a computer simulation.

FIG. 5 is specifications of a transmission signal in a computer simulation.

FIG. 6 illustrates specifications of antenna arrangement for comparison and evaluation by computer simulation.

FIG. 7 is a diagram illustrating comparison of arrangements.

FIG. 8 is a simulation result.

FIG. 9 is a view illustrating a first specific example of two-dimensional arrangement.

FIG. 10 is a view illustrating a second specific example of two-dimensional arrangement.

### DESCRIPTION OF EMBODIMENTS

### [Conditions for Occurrence of Primary Dependency of Steering Vector]

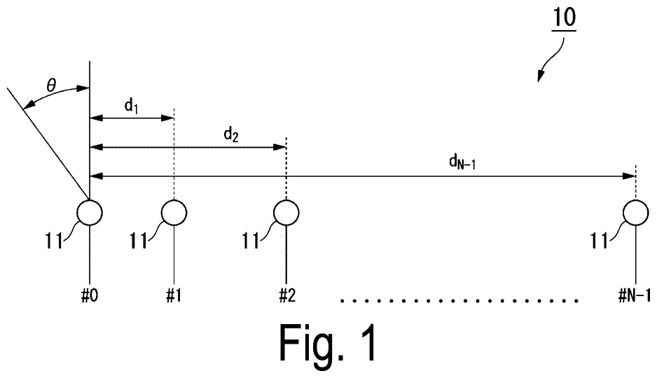

In an antenna device configured as an array antenna, a condition in which primary dependency of a steering vector occurs due to spatial aliasing will be described. FIG. 1 is a diagram illustrating a specific example of arrangement of antenna elements 11 in an antenna device 10 configured as an array antenna. The antenna device 10 includes at least three antenna elements 11. The antenna element 11 receives a wave such as a radio wave or a sound wave (including an ultrasonic wave) and generates an electric signal corresponding to the wave.

The antenna elements 11 are arranged one-dimensionally or two-dimensionally. With such an arrangement, the antenna device 10 is configured as an array antenna. In the example of FIG. 1, N antenna elements 11 are arranged on a one-dimensional line. That is, the antenna device 10 in the example of FIG. 1 is configured as a linear array. The antenna elements 11 are denoted by reference signs #0 to #N−1.

With the antenna element 11 of #0 as a reference point, the antenna element of #i is arranged at a position separated by d_i. Note that the notation “A_B” indicates notation in which “B” is arranged as a suffix at the lower right of “A”. It is assumed that the received wave (including the desired wave and the unwanted wave) is incident from any direction of the angle θ (θ is −π/2 to +π/2).

When the steering vector corresponding to the incidence angle θ and the steering vectors corresponding to the other arrival directions θ_d (θ_d is −π/2 to +π/2) are primary dependent on each other, the following conditional expression (Expression 1) is satisfied.

$$\begin{matrix}[ Math . 1 ] & \\ sin {θ}_{d} = sin θ + \frac{{α}_{1} λ}{{d}_{1}} = sin θ + \frac{{α}_{2} λ}{{d}_{2}} = … = sin θ + \frac{{α}_{N - 1} λ}{{d}_{N - 1}} & ( Expression 1 )\end{matrix}$$

Here, λ is a wavelength corresponding to any frequency in the transmission band. The transmission band is a band assumed to be used in transmission of a desired wave (direct wave) to be received. α_n (n=0, . . . , N−1) is an integer other than 0. A numerical range of each α_n is expressed by the following Expression 2.

$$\begin{matrix}[ Math . 2 ] & \\ - 1 < sin θ + \frac{{α}_{n} λ}{{d}_{n}} < 1 & ( Expression 2 )\end{matrix}$$

Expression 3 can be obtained by rearranging Expression 1.

$$\begin{matrix}[ Math . 3 ] & \\ \frac{{α}_{1}}{{d}_{1}} = \frac{{α}_{2}}{{d}_{2}} = … = \frac{{α}_{N - 1}}{{d}_{N - 1}} & ( Expression 3 )\end{matrix}$$

m and n are each a set of integers of 1 or more and (N−1) or less. In a case where there is at least one set of α_1, . . . , and α_(N−1) satisfying the following Expression 4 for all m and n pairs in which m and n are different, one or more primary dependent arrival directions are generated in a direction different from the incidence angle θ. In other words, in a case where α_1 to α_(N−1) are a set satisfying Expression 3, one or more primary dependent arrival directions are generated in a direction different from the incidence angle θ.

$$\begin{matrix}[ Math . 4 ] & \\ \frac{{α}_{m}}{{α}_{n}} = \frac{{d}_{m}}{{d}_{n}} & ( Expression 4 )\end{matrix}$$

$${α}_{1} , … , {α}_{N - 1} such that \frac{{α}_{m}}{{α}_{n}} = \frac{{d}_{m}}{{d}_{n}} {∀}_{n} \neq m$$

[Condition Under which No Primary Dependency of Steering Vector Occurs]

Next, a condition under which the primary dependency of the steering vector does not occur will be described. The condition under which the primary dependency of the steering vector does not occur within the transmission band is that in which there is at least one set of d_n and d_m that does not satisfy the above-described Expression 4 for any 0 of −π/2 to +π/2.

For example, when the ratio (d_n′/d_m′) of at least one element interval of the set of d_n and d_m is an irrational number, there is no integer ratio that satisfies the condition of Expression 4 regardless of the value of 0. Thus, when the ratio of the element intervals is an irrational number as described above, the primary dependency of the steering vector does not occur for any angle or wavelength. The arrangement of the antenna elements 11 under such conditions is referred to as a first arrangement.

For example, d_1 is a value equal to or more than ½ of the minimum wavelength in the transmission band and less than the minimum wavelength. In this case, α_1 can take only +1 or −1 for all wavelengths in the transmission band. If d_2 is arranged not to be an integral multiple of d_1, there is no primary dependency of the steering vector. The arrangement of the antenna elements 11 under such conditions is referred to as a second arrangement.

For example, the following Expression 5 can be obtained from the inequality evaluation of Expression 2.

$$\begin{matrix}[ Math . 5 ] & \\ sin θ + \frac{{α}_{n} λ}{{d}_{n}} < 1 ⇔ {α}_{n} < \frac{{d}_{n}}{λ} ( 1 - sin θ ) < \frac{2 {d}_{N - 1}}{{λ}_{min}} & ( Expression 5 )\end{matrix}$$

Here, λ_min is the minimum wavelength in the transmission band. The following events can be derived from Expression 5. In a case where the ratio between d_n and d_m is expressed as d_n/d_m=p_n/p_m using the mutually prime numbers p_n and p_m, if both p_n and p_m are larger than (2d_(N−1))/λ_min, there is no set of integers α_n and α_m satisfying Expression 4. That is, when the above-described condition is satisfied, the primary dependency of the steering vector does not occur. The arrangement of the antenna elements 11 under such conditions is referred to as a third arrangement.

### [Configuration of Reception System]

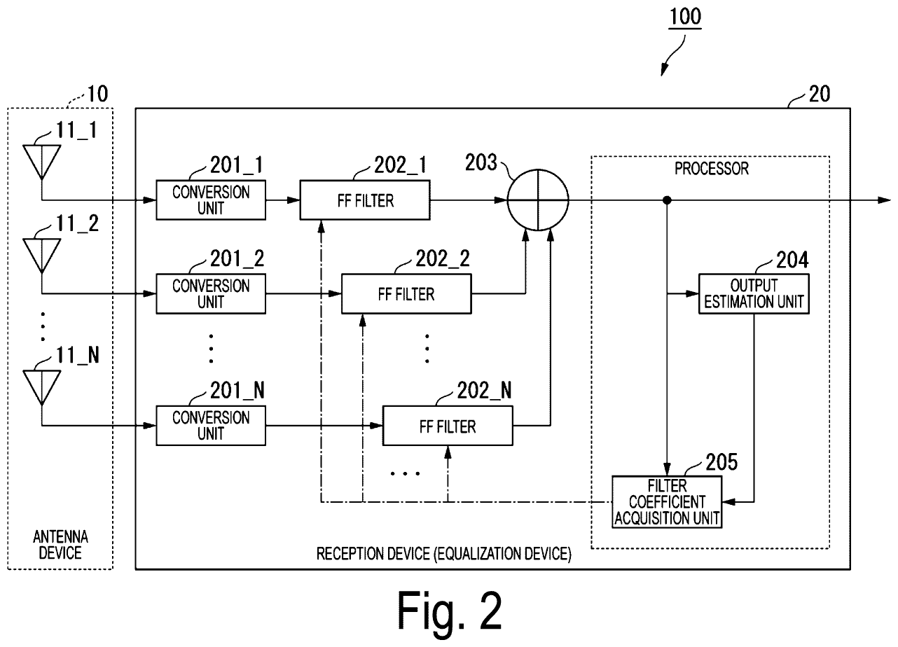

Next, the reception system 100 including the antenna device 10 will be described. FIG. 2 is a diagram illustrating a configuration example of the reception system 100. The reception system 100 includes an antenna device 10 and a reception device 20.

The antenna device 10 is an array antenna. The antenna device 10 includes at least three or more antenna elements 11. In the following description, the number of antenna elements 11 included in the antenna device 10 is represented as N (N is an integer of 3 or more). In the antenna device 10, the N antenna elements 11 are arranged so as not to satisfy the above-described primary dependency occurrence condition (Expression 4) of the steering vector. The arrangement of the antenna elements 11 may be a one-dimensional array arrangement or a two-dimensional array arrangement.

The reception device 20 includes N conversion units 201 (201_1 to 201_N), N FF filters 202 (202_1 to 202_N), a synthesizer 203, an output estimation unit 204, and a filter coefficient acquisition unit 205. N is the same value as the number of antenna elements 11 included in the antenna device 10. As described above, it is desirable that the number of conversion units 201 and the number of FF filters 202 be equal to the number of antenna elements 11. If some functions are not used, all are not necessarily the same. In the following description, a configuration common to the N devices having the same names will be described by omitting reference signs such as “_1”. For example, the conversion unit is described as “conversion unit 201” instead of “conversion unit 201_1”.

The conversion unit 201 samples the electric signal converted by antenna element 11 of antenna device 10. Specifically, it is as follows. The conversion unit 201 performs analog-to-digital conversion on the electrical signal converted by the antenna element 11. Then, the conversion unit 201 performs frequency conversion on the digital signal obtained by the analog-to-digital conversion. Note that other configurations (modifications) may be adopted for the conversion unit 201. For example, the conversion unit 201 may be configured to perform only analog-to-digital conversion. For example, the conversion unit 201 may be configured to perform frequency conversion on the analog signal and then perform analog-to-digital conversion.

The FF filter 202 performs a waveform operation on the signal sampled by the conversion unit 201. The FF filter 202 outputs the waveform-operated signal to the synthesizer 203.

The synthesizer 203 synthesizes the N signals subjected to the waveform operation by the FF filter 202.

The output estimation unit 204 may temporarily determine the output of the synthesizer 203 on the basis of the signal synthesized by the synthesizer 203. The output estimation unit 204 may calculate a desired response using the signal synthesized by the synthesizer 203 and the training signal. The desired response may be, for example, a symbol included in the signal of the desired wave received by the antenna device 10.

The filter coefficient acquisition unit 205 adaptively acquires filter coefficients of the N FF filters 202. The filter coefficient acquisition unit 205 may acquire the filter coefficient by calculation, for example, or may acquire the filter coefficient on the basis of a preset lookup table.

The filter coefficient acquisition unit 205 may be configured to include, for example, an error calculation unit and an adaptive algorithm unit. The error calculation unit calculates an error between output of an equalization device and a desired response. The adaptive algorithm unit adaptively updates the filter coefficient based on the error calculated by the error calculation unit, and optimizes the filter coefficient based on a standard such as a least square error. The adaptive algorithm includes a means for recursively calculating a filter coefficient, such as a least mean square (LMS) method, a recursive least square (RLS) method, or an affine projection algorithm (APA) method. Examples of the adaptive algorithm also include algorithms derived from these.

The output estimation unit 204 and the filter coefficient acquisition unit 205 each include a processor such as a CPU and a memory. The output estimation unit 204 and the filter coefficient acquisition unit 205 operate by the processor reading and executing a program stored in the storage device. The program may be recorded on a computer-readable recording medium. The computer-readable recording medium is, for example, a non-transitory storage medium including a portable medium such as a flexible disk, a magneto-optical disc, a ROM, or a CD-ROM and a storage device such as a hard disk built in a computer system. The program may be transmitted via an electrical communication line. Some or all of the operations of the output estimation unit 204 and the filter coefficient acquisition unit 205 may be realized using hardware including an electronic circuit using, for example, an LSI, an ASIC, a PLD, an FPGA, or the like.

Note that the reception device 20 may further include an FB filter and a digital PLL (DPLL) as described in Non Patent Literatures 1 and 2.

### [Details of Antenna Device]

Next, a configuration of the antenna device 10 will be described in detail. As described above, in the arrangement of the antenna elements 11 in the antenna device 10, there is no primary dependent set of arrival directions with completely matching steering vectors. Therefore, there is an FF filter coefficient in which gains in two arbitrary directions do not match. That is, independent control in two directions such as making the reception gain of the unwanted wave smaller than that of the desired wave is possible regardless of the combination of the arrival directions. As a result, the degree of freedom of control in the adaptive algorithm increases, and suppression of an unwanted wave and extraction of a desired wave can be effectively performed.

As described above, specific examples of the arrangement of the antenna elements 11 include a first arrangement, a second arrangement, and a third arrangement. Each specific example will be described.

### [First Arrangement]

In the first arrangement, there is at least one combination of the intervals of the antenna elements 11 having an irrational number ratio. For example, the antenna elements 11 may be arranged so as to satisfy following Expression 6.

[Math. 6]

dₙ=γ,dₘ=Mₒγ (Expression 6)

In Expression 6, d_n and d_m are as shown in FIG. 1. M_o is an irrational number. n and m are mutually different integers of 1 or more and (N−1) or less. According to the condition of Expression 6, d_n/d_m=1/M_o. In this way, by arranging the antenna elements 11 so as to satisfy Expression 6, d_n/d_m becomes an irrational number ratio. Therefore, Expression 4 is not satisfied. As a result, there is always no primary dependency of the steering vector.

In actual operation, since the installation interval of the antenna element 11 is an approximate value of the irrational number ratio, a value sufficiently approximating the irrational number may be used.

### [Second Arrangement]

In the second arrangement, d_1 is ½ or more of the minimum wavelength in the transmission band and less than the minimum wavelength. At least one of d_2 to d_(N−1) is not an integral multiple of d_1. That is, the antenna element 11 is arranged so as to satisfy following Expression 7 and satisfy the condition that d_n and kd_l are different (k is a natural number) with any n (n is 2 or more and less than (N−1)).

[Math. 7]

λₘᵢₙ/2<d₁<λₘᵢₙ (Expression 7)

### [Third Arrangement]

In the third arrangement, both p_n′ and p_m′ have a value larger than (2d_(N−1))/λmin when the ratio of the antenna element interval of at least one of the pair of d_n and d_m is represented by a relatively prime factor p_n′/p_m′. That is, the antenna element 11 is arrayed so as to satisfy the condition that d_n=γP_n, d_m=γP_m, γ is a real number, P_n, and P_m are relatively prime integers, and the condition of following Expression 8 is satisfied by any set of n and m (n and m are 1 or more and (N−1) or less).

$$\begin{matrix}[ Math . 8 ] & \\ {P}_{n} , {P}_{m} > \frac{2 {d}_{N - 1}}{{λ}_{min}} & ( Expression 8 )\end{matrix}$$

### EXAMPLES

Next, a result of computer simulation of the reception system 100 using the antenna devices 10 of the first arrangement, the second arrangement, and the third arrangement described above with respect to the reception system using the antenna devices of the general equal interval arrangement and the effect will be described.

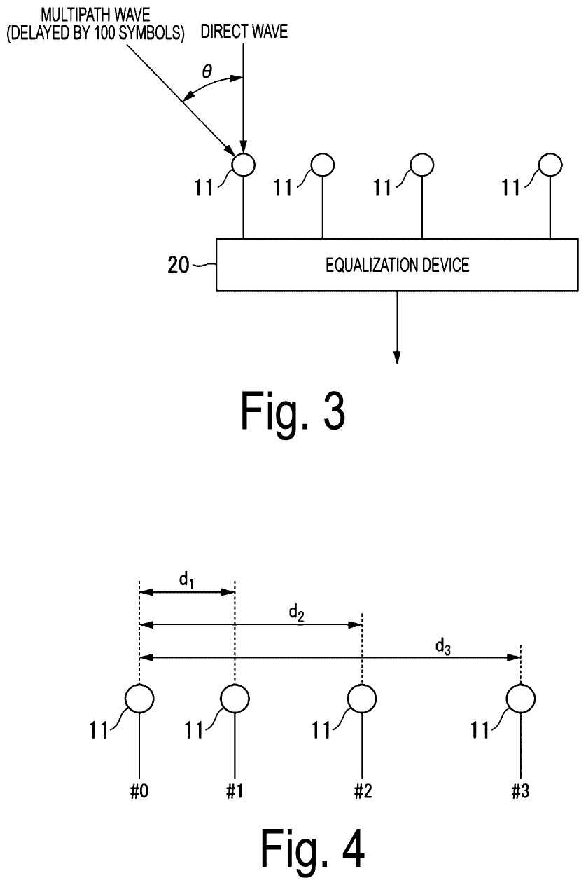

FIGS. 3 and 4 are diagrams illustrating an outline of computer simulation. In this simulation, a linear array is assumed, and a direct wave (desired wave) is incident from a direction orthogonal to the arrangement direction of the linear array. Further, the multipath wave delayed by 100 symbols is made incident from the θ (θ is a value between 0 and π/2) direction. The equalization device is the same as the configuration illustrated in FIG. 2, and extracts a direct wave on the basis of a training sequence and removes a multipath wave. Equalization performance is evaluated by evaluating a mean square error (MSE) between the desired signal and the output value of the equalization device.

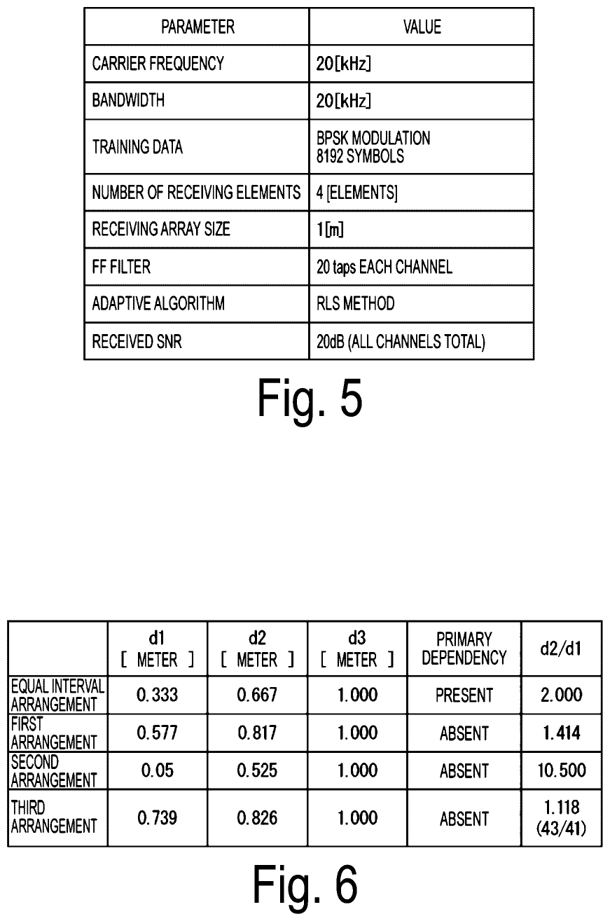

The table illustrated in FIG. 5 is specifications of the transmission signal in the computer simulation. The table illustrated in FIG. 6 is specifications of antenna arrangement for which comparison and evaluation are performed by the computer simulation. The aperture diameter of the array antenna is set to 1 m in common for all the arrangements of the four patterns in order to make the angular resolution uniform. The equal interval arrangement is a general arrangement to be compared, and has primary dependency of a steering vector. The first to third arrangements are the arrangement configurations described above. In the first arrangement, d_2/d_1 is the route 2 (2 to the power of ½). In the second arrangement, d_1 is one wavelength (0.05 m), and d_2/d_1=10.5. In the third arrangement, in this simulation, the array is arranged at a ratio of d_2/d_1=43/41 with respect to following Expression 9.

$$\begin{matrix}[ Math . 9 ] & \\ \frac{2 {d}_{N - 1}}{{λ}_{min}} = 40 & ( Expression 9 )\end{matrix}$$

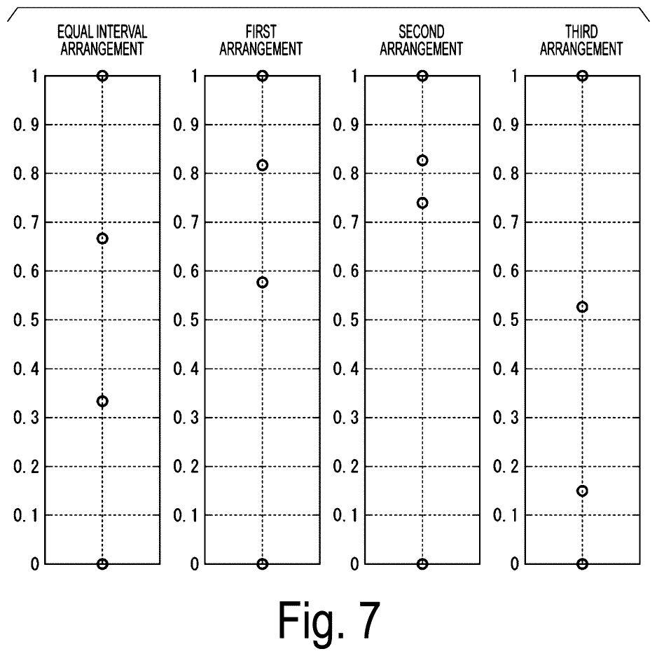

A comparison of the arrangements is illustrated in FIG. 7.

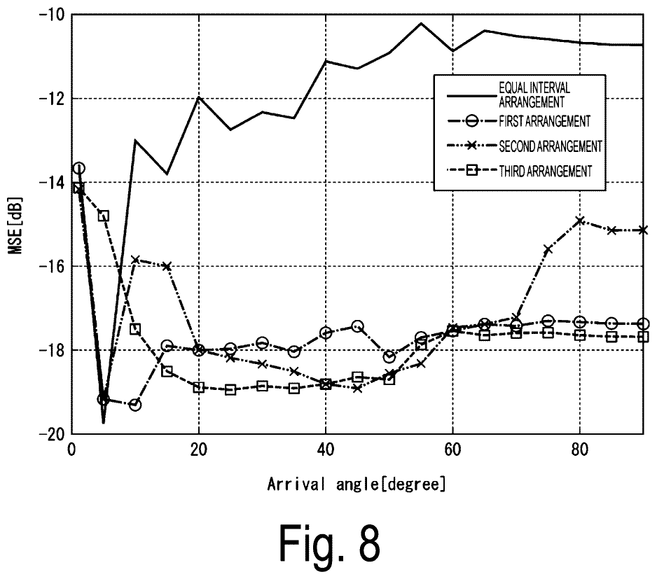

FIG. 8 is a simulation result. The horizontal axis represents the arrival direction of the delayed wave, and the vertical axis represents the mean square error from the desired signal (signal indicated by the desired wave). It can be said that as the mean square error is smaller, interference due to unwanted waves can be effectively removed. As a result, in the equal interval arrangement, the suppression performance of the interference wave decreases after the angle (8.7 degrees) at which spatial aliasing occurs at the highest frequency (30 kHz) of the band. On the other hand, in the first arrangement to the third arrangement, it can be seen that the better performance can be achieved at the arrival angle of 10 degrees or more than in the equal interval arrangement and the equalization performance is improved.

The above evaluation results indicate that the effect of improving the equalization performance can be obtained by the first arrangement to the third arrangement.

As described above, by using the antenna device 10 adopting any of the first arrangement, the second arrangement, and the third arrangement, it is possible to improve the accuracy of the equalization processing on the received signal.

In particular, in broadband underwater communication, wavelength lengths often differ twice or more within a frequency band. Since the relationship of the arrival direction in which spatial aliasing occurs is different for each wavelength in the band, the above problem becomes more serious in underwater communication, and it becomes difficult to remove unwanted waves from all directions. Even in such a situation, the accuracy of the equalization processing on the received signal can be improved using the antenna device 10 adopting any of the first arrangement, the second arrangement, and the third arrangement as described above.

Hereinafter, a modification of the antenna device 10 will be described. In the above description, the antenna elements 11 in the antenna device 10 are arranged one-dimensionally, but the antenna elements 11 may be arranged two-dimensionally. In this case, the beam is scanned two-dimensionally, and the antenna device 10 effectively works against interference waves from two directions of the elevation angle and the azimuth angle.

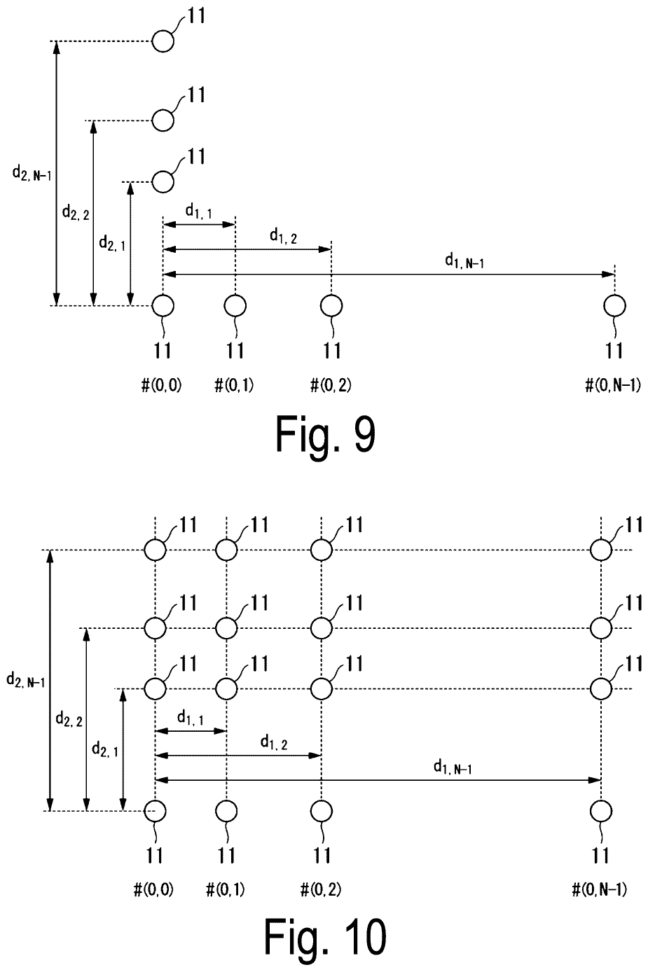

FIG. 9 is a diagram illustrating a first specific example of the two-dimensional arrangement. FIG. 10 is a view illustrating a second specific example of the two-dimensional arrangement. In FIG. 9, the antenna elements 11 are arranged in one row along the first axis and one row along the second axis, respectively. The first axis and the second axis are orthogonal to each other. Specifically, in FIG. 9, the antenna elements 11 are arranged in an L shape. In addition to the L shape, a cross array or another two-dimensional array may be used. In addition, each of the first axis and the second axis may not be one row, and a plurality of rows may be arranged. In FIG. 10, the antenna elements 11 are arranged in a rectangular shape along the first axis and the second axis.

In the arrangement examples of FIGS. 9 and 10, a set of arrangement intervals d_(1,1) to d_(1, N−1) does not satisfy the condition of Expression 4, and a set of d_(2,1) to d_(2, N−1) does not satisfy the condition of Expression 4. The set of the arrangement intervals d_(1,1) to d_(1, N−1) may be any of the first arrangement to the third arrangement. The set of the arrangement intervals d_(2,1) to d_(2, N−1) may be any of the first arrangement to the third arrangement. At this time, the arrangement pattern of the arrangement intervals d_(1, 1) to d_(1, N−1) and the arrangement pattern of d_(2,1) to d_(2, N−1) may be the same or different. For example, a set of the arrangement intervals d_(1, 1) to d_(1, N−1) may be configured as the first arrangement, and a set of d_(2,1) to d_(2, N−1) may also be configured as the first arrangement. Further, for example, a set of the arrangement intervals d_(1,1) to d_(1, N−1) may be configured as the first arrangement, and a set of d_(2,1) to d_(2, N−1) may be configured as the second arrangement.

In addition, it may be configured such that a set of the arrangement intervals d_(1, 1) to d_(1, N−1) does not satisfy the condition of Expression 4, and a set of d_(2,1) to d_(2, N−1) satisfies the condition of Expression 4. In addition, it may be configured such that a set of the arrangement intervals d_(1,1) to d_(1,N−1) satisfies the condition of Expression 4, and a set of d_(2,1) to d_(2, N−1) does not satisfy the condition of Expression 4. In such a configuration, there is a possibility that the performance is lower than that of a configuration in which the set of the above-described arrangement intervals d_(1, 1) to d_(1, N−1) does not satisfy the condition of Expression 4 and the set of the arrangement intervals d_(2,1) to d_(2, N−1) does not satisfy the condition of Expression 4, but it is possible to improve the performance at least as compared with the conventional configuration.

In addition, as illustrated in FIG. 7, they may be arranged in a mesh grid in two dimensions. In the arrangement illustrated in FIGS. 9 and 10, there is no primary dependent set of steering vectors in any of the two-dimensional directions. Therefore, equalization performance can be improved.

In the examples of FIGS. 9 and 10, the first axis and the second axis are orthogonal to each other, but may not necessarily be orthogonal to each other.

Although the embodiments of the present invention have been described in detail with reference to the drawings, the specific configuration is not limited to the embodiments, and includes design and the like without departing from the spirit of the present invention.

### INDUSTRIAL APPLICABILITY

The present invention can be applied to a technique for receiving radio waves and sound waves (including ultrasonic waves).

### REFERENCE SIGNS LIST

10 Antenna device
11 Antenna element
20 Reception device (equalization device)
201 Conversion unit
202 FF filter
203 Synthesizer
204 Output estimation unit
205 Filter coefficient acquisition unit

1. An antenna device comprising N (N is an integer of 3 or more) antenna elements that receive a sound wave or a radio wave,
wherein the N antenna elements are arranged at a position where a steering vector corresponding to an incidence angle θ of a certain sound wave or radio wave and a steering vector corresponding to an incidence angle θ_d (@_d is −π/2 to +π/2) of another sound wave or radio wave are not primarily dependent on each other.

2. The antenna device according to claim 1, wherein
when m and n are integers of 1 or more (N−1) or less,
α_m and α_n are integers of 1 or more (N−1) or less, and
a position at which an m-th antenna element is arranged is d_m and a position at which an n-th antenna element is arranged is d_n,
the condition of not being primarily dependent is that there is at least one set of d_n and d_m that does not satisfy following (Expression 4) for any θ of −π/2 to +π/2.
$$\frac{{α}_{m}}{{α}_{n}} = \frac{{d}_{m}}{{d}_{n}} \qquad ( Expression 4 )$$
$${α}_{1} , … , {α}_{N - 1} such that \frac{{α}_{m}}{{α}_{n}} = \frac{{d}_{m}}{{d}_{n}} {∀}_{n} \neq m$$

3. The antenna device according to claim 2, wherein
when γ is a real number, and
M_o is an irrational number,
the N antenna elements are arranged to satisfy following (Expression 6).
dₙ=γ,dₘ=Mₒγ (Expression 6)

4. The antenna device according to claim 2, wherein
when λ_min is a minimum wavelength in the transmission band,
the N antenna elements are arranged to satisfy a condition that following (Expression 7) is satisfied and d_n and kd_1 are different (k is a natural number) by any n (n is 2 or more and less than (N−1)).
λₘᵢₙ/2<d₁<λₘᵢₙ (Expression 7)

5. The antenna device according to claim 2, wherein
when P_n and P_m are relatively prime integers,
γ is a real number,
d_n=γP_n,
d_m=γP_m, and
λ_min is a minimum wavelength in the transmission band,
the N antenna elements are arranged to satisfy a condition that a condition of following (Expression 8) is satisfied by any set of n and m (n and m are 1 or more and (N−1) or less).
$${P}_{n} , {P}_{m} > \frac{2 {d}_{N - 1}}{{λ}_{min}} \qquad ( Expression 8 )$$

6. A reception system comprising: the antenna device according to claim 2; and a reception device, wherein
the reception device includes:
N conversion units that sample electric signals converted by the N antenna elements;
N filters that perform waveform operation on the signals sampled by the N conversion units;
a synthesizer that synthesizes N signals after waveform operation is performed by the N filters;
an output estimation unit that estimates an output of the synthesizer based on the signal after being synthesized by the synthesizer; and
a filter coefficient acquisition unit that acquires a filter coefficient based on the signal after being synthesized by the synthesizer and the output estimated by the output estimation unit.
